(19) United States
(12) Patent Application Publication
(10) Pub. No.: US 2026/0344729 A1
(43) Pub. Date: Nov. 5, 2026

(54) EDIBLE TRANSFERABLE HOLOGRAPHIC IMAGE FILMS AND METHODS

(71) Applicant: Trustees of Tufts College, Medford, MA (US)

(72) Inventors: Fiorenzo G. Omenetto, Lexington, MA (US); Giulia Guidetti, Somerville, MA (US)

(21) Appl. No.: 19/558,026

(22) Filed: Mar. 5, 2026

Related U.S. Application Data
(63) Continuation of application No. PCT/US24/45544, filed on Sep. 6, 2024.
(60) Provisional application No. 63/580,896, filed on Sep. 6, 2023.

(51) Int. Cl. A23P 20/20; A23P 20/10; G03H 1/00; G03H 1/02

(52) U.S. Cl. CPC A23P 20/20; A23P 20/105; G03H 1/0005; G03H 1/0272; G03H 2001/0264; G03H 2210/63; G03H 2240/55; G03H 2270/12

(57) ABSTRACT

Edible transferable holographic image films are disclosed. Food products including these films can have a holographic image on a surface to which the film is applied. The films include a holographic image pattern on a first film surface and a non-patterned substrate portion. The beta-sheet crystallinity is tuned to sustain the holographic image pattern through exposure to various conditions that typically result in a loss of food image. The films include fine physical features that generate the holographic image while achieving an excellent image fidelity when used.

### CLAIM TO PRIORITY

This application claims benefit of and is a continuation of International Patent Application No. PCT/US2024/045544 (Attorney Docket No. 2095.0627), filed Sep. 6, 2024, and entitled “EDIBLE TRANSFERABLE HOLOGRAPHIC IMAGE FILMS AND METHODS,” International Pub. No. WO2025054426, which is hereby incorporated by reference in its entirety for all purposes.

International Patent Application No. PCT/US2024/045544 relates to, incorporates by reference for all purposes, and claims priority to U.S. Provisional Application No. 63/580,896 (Attorney Docket No. 2095.0541), filed Sep. 6, 2023.

### STATEMENT REGARDING FEDERALLY SPONSORED RESEARCH

This invention was made with government support under N00014-19-2399 awarded by the Department of Defense. The government has certain rights in the invention.

### SUMMARY

In one aspect, the present disclosure provides a food product having an edible transferable holographic image film on at least one surface of the food product. The edible transferable holographic image film includes silk fibroin in an amount by weight of at least 50%, at least 60%, at least 70%, at least 80%, at least 90%, or 100%. The edible transferable holographic image film has a holographic image pattern on a first film surface and a non-patterned substrate portion. The edible transferable holographic image film has a total thickness of between 5 μm and 50 μm. The holographic image pattern has an image pattern thickness of between 150 nm and 3 μm. The holographic image pattern has lateral image feature dimensions of between 150 nm and 5 μm. The non-patterned substrate portion has a substrate thickness of between 4.85 μm and 49.85 μm. The edible transferable holographic image film has a degree of beta-sheet crystallinity that is tuned to sustain the holographic image pattern through exposure for at least an exposure length of time to either: a temperature exceeding 40 °C and/or a relative humidity exceeding 95%. The exposure length of time is between 2 hours and 24 hours.

In another aspect, the present disclosure provides a method of making a transferable holographic image film. The method includes: cast molding a silk fibroin solution onto a holographic image mold; during or after the cast molding, tuning a degree of beta sheet crystallinity in the edible transferable holographic image film; removing the edible transferable holographic image film from the holographic image mold. The tuning the degree of beta sheet crystallinity is tailored to sustain the holographic image pattern through exposure for at least an exposure length of time to either: a temperature exceeding 40 °C and/or a relative humidity exceeding 95%. The exposure length of time is between 2 hours and 24 hours. The silk fibroin solution has a silk fibroin concentration by weight of between 0.01% and 1%. The holographic image mold has a depth dimension of between 150 nm and 3 μm and lateral dimensions of between 150 nm and 5 μm. The cast molding thereby forms the edible transferable holographic image film within the mold. Removing the edible transferable holographic image film from the holographic image mold and applying it to a food product produces an image fidelity of at least 90%, at least 95%, at least 98%, or at least 99%. The edible holographic image film having the properties disclosed in the preceding paragraph and elsewhere herein.

In yet another aspect, the present disclosure provides an edible transferable holographic image film having the properties described in either of the two preceding paragraphs and disclosed elsewhere herein.

In a further aspect, the present disclosure provides a method of using an edible transferable holographic image film. The method includes applying a first instance of the edible holographic image film to a first surface of a food product.

These and other systems, methods, objects, features, and advantages of the present disclosure will be apparent to those skilled in the art from the following detailed description of the preferred embodiment and the drawings.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 is a schematic representation of the fabrication process of holographic coatings on food using silk solution to obtain holographic transfer films.

### DETAILED DESCRIPTION

Before the present disclosure is described in further detail, it is to be understood that the disclosure is not limited to the particular embodiments described. It is also understood that the terminology used herein is for the purpose of describing particular embodiments only, and is not intended to be limiting. The scope of the present disclosure will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, “silk fibroin” refers to silk fibroin protein whether produced by silkworm, spider, or other insect, or otherwise generated (Lucas et al., Adv. Protein Chem., 13: 107-242 (1958)). Any type of silk fibroin can be used in different embodiments described herein. Silk fibroin produced by silkworms, such as Bombyx mori, is the most common and represents an earth-friendly, renewable resource. For instance, silk fibroin used in a silk film may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants, and variants thereof, that can be used. See, e.g., WO 97/08315 and U.S. Pat. No. 5,245,012, each of which is incorporated herein by reference in their entireties.

As used herein, “holographic” refers to an image or a pattern generated by the interference of light with a patterned material. One example of a holographic image is an image formed from a grating having certain dimensions with respect to the wavelength of visible light, as described herein. In general, a grating pattern with proper dimensions relative to the wavelength of visible light is one example of a holographic pattern.

As used herein, “image fidelity” is a statistical measure of the reproducibility of providing an image with a given modality. In the case of transferable edible films, image fidelity relates to a statistical measure of reproducibly providing a given image on a desired food surface following the transfer process. Without wishing to be limited by a specific statistical measure, a statistically significant number of transferable films can be produced and measured for individual performance in transferring the desired image to a food product, with the individual performances being tallied into a statistical measure of overall image fidelity. It should be appreciated that for many industrial processes, there is a fail rate. One of the impressive technical achievements in this case is lowering that fail rate in transferring holographic images in an edible environment and image fidelity is one measurable way of reflecting that.

The present disclosure provides a food product having an edible transferable holographic image film on at least one surface of the food product. Unless expressly indicated otherwise, features described elsewhere herein relating to the food product and/or the edible transferable holographic image film in other contexts (e.g., in the context of a film or a method) are applicable here to the edible transferable holographic image film and vice versa.

Without wishing to be bound by any particular theory, it is believed that prior efforts at forming edible transferable holographic image films have been frustrated by some technical shortcomings. These technical shortcomings result in a lack of image fidelity when transferring images, so the resulting food products have a high error rate.

The fine features that are required for forming a holographic image film have traditionally been challenging to form within otherwise thin films. Freestanding holographic images have been formed in a more trivial technical environment where films are thicker, but this achievement has not been translated into the thin film environment which is often necessary in a food context.

The edible transferable holographic image film is composed of silk fibroin in an amount by weight of at least 50%. In some cases, the edible transferable holographic image film is composed of silk fibroin in an amount by weight of at least 60%. In some cases, the edible transferable holographic image film is composed of silk fibroin in an amount by weight of at least 70%. In some cases, the edible transferable holographic image film is composed of silk fibroin in an amount by weight of at least 80%. In some cases, the edible transferable holographic image film is composed of silk fibroin in an amount by weight of at least 90%. In some cases, the edible transferable holographic image film is composed of silk fibroin in an amount by weight of 100%.

The edible transferable holographic image film includes a holographic image pattern on a first surface and a non-patterned substrate portion. The holographic image pattern is the portion of the edible transferable holographic image film that is responsible for generating the holographic image. The non-patterned substrate portion is primarily present for structural support.

The edible transferable holographic image film has a total thickness of between 5 μm and 50 μm. The total thickness can be at least 5 μm, at least 10 μm, at least 15 μm, or at least 20 μm. The total thickness can be at most 50 μm, at most 40 μm, at most 30 μm, at most 25 μm, at most 20 μm, at most 15 μm, or at most 10 μm. Without wishing to be bound by any particular theory, it is believed that the edible transferable holographic image film may need to be particularly thin, so that it does not unduly impact the flavor or texture profile of the food product. Without wishing to be bound by any particular theory, it is believed that achieving the fine features required for a holographic image pattern within a thin film is a particularly challenging technical achievement.

The holographic image pattern has an image pattern thickness of between 150 nm and 3 μm. The image pattern thickness can be at least 150 nm, at least 200 nm, at least 250 nm, at least 300 nm, at least 400 nm, at least 475 nm, at least 500 nm, at least 600 nm, at least 750 nm, or at least 1 μm. The image pattern thickness can be at most 3 μm, at most 2.5 μm, at most 2 μm, or at most 1 μm. Without wishing to be bound by any particular theory, it is believed that achieving a high image fidelity with an image pattern thickness as disclosed is highly challenging.

The holographic image pattern has lateral image feature dimensions of between 150 nm and 5 μm. The lateral image feature dimensions can be at least 150 nm, at least 200 nm, at least 250 nm, at least 300 nm, at least 400 nm, at least 475 nm, at least 500 nm, at least 600 nm, at least 750 nm, or at least 1 μm. The lateral image feature dimensions can be at most 5 μm, at most 4 μm, at most 3 μm, at most 2.5 μm, at most 2 μm, or at most 1 μm. Without wishing to be bound by any particular theory, it is believed that achieving a high image fidelity with lateral image feature dimensions as disclosed is highly challenging.

The non-patterned substrate portion has a substrate thickness of between 4.85 μm and 49.85 μm. The substrate thickness can be at least 4.85 μm, at least 5 μm, at least 10 μm, at least 15 μm, or at least 20 μm. The substrate thickness can be at most 49.85 μm, at most 40 μm, at most 30 μm, at most 25 μm, at most 20 μm, at most 15 μm, or at most 10 μm. A skilled artisan will appreciate that the values disclosed here account for the 150 nm minimal thickness of the holographic image pattern, but otherwise the values including the 0.85 decimal can be reasonably substituted by their nearest integer value (e.g., a thickness of between 5 μm and 50 μm).

The edible transferable holographic image film has a degree of beta-sheet crystallinity that is tuned to sustain, or enable the endurance of, the holographic image pattern through exposure for an exposure length of time to various conditions that are typically deleterious to food images. The exposure can be to a temperature exceeding 40 °C. The exposure can be to a relative humidity exceeding 95%. The exposure length of time is between 2 hours and 24 hours. In some cases, the exposure length of time can be greater than 24 hours. In some cases, the exposure length of time is at least 3 hours. In some cases, the exposure length of time is at least 6 hours. In some cases, the exposure length of time is at least 9 hours. In some cases, the exposure length of time is at least 12 hours. In some cases, the exposure length of time is at least 15 hours. In some cases, the exposure length of time is at least 18 hours. In some cases, the exposure length of time is at most 20 hours. In some cases, the exposure length of time is at most 16 hours. In some cases, the exposure length of time is at most 12 hours. In some cases, the exposure length of time is at most 8 hours. In some cases, the exposure length of time is between 4 and 6 hours. In some cases, the exposure length of time is between 5 and 8 hours. In some cases, the exposure length of time is between 10 and 12 hours. In some cases, the exposure length of time is between 4 and 12 hours. In some cases, the exposure length of time is between 10 and 18 hours. In some cases, the exposure length of time is between 18 and 24 hours.

In some cases, the beta-sheet crystallinity is tuned to sustain the holographic image pattern through exposure to a temperature exceeding 40 °C for between 2 hours and 24 hours. In some cases, the beta-sheet crystallinity is tuned to sustain the holographic image pattern through exposure to a temperature exceeding 40 °C for greater than 24 hours, at least 3 hours, at least 6 hours, at least 9 hours, at least 12 hours, at least 18 hours, or at most 20 hours, at most 16 hours, at most 12 hours, or at most 10 hours. In some cases, the beta-sheet crystallinity is tuned to sustain the holographic image pattern through exposure to a temperature exceeding 40 °C between 4 and 6 hours, between 5 and 8 hours, between 10 and 12 hours, between 4 and 12 hours, between 10 and 18 hours, or between 18 and 24 hours.

In some cases, the beta-sheet crystallinity is tuned to sustain the holographic image pattern through exposure to a relative humidity exceeding 95% for between 2 hours and 24 hours. In some cases, the beta-sheet crystallinity is tuned to sustain the holographic image pattern through exposure to a relative humidity exceeding 95% for greater than 24 hours, at least 3 hours, at least 6 hours, at least 9 hours, at least 12 hours, at least 18 hours, or at most 20 hours, at most 16 hours, at most 12 hours, or at most 10 hours. In some cases, the beta-sheet crystallinity is tuned to sustain the holographic image pattern through exposure to a relative humidity exceeding 95% between 4 and 6 hours, between 5 and 8 hours, between 10 and 12 hours, between 4 and 12 hours, between 10 and 18 hours, or between 18 and 24 hours.

The tuning of the beta-sheet crystallinity can be done by techniques known to those having ordinary skill in the art, including but not limited to, water vapor annealing.

The relative thickness of the image pattern thickness and the substrate thickness can impact performance. The ratio between the image pattern thickness and the substrate thickness is between 1:5000 and 1:2. In some cases, the ratio is at least 1:5000, at least 1:2500, at least 1:1000, at least 1:500, at least 1:250, at least 1:100, at least 1:75, at least 1:50, at least 1:25, at least 1:10, at least 1:5, at least 1:4, or at least 1:3. The ratio can be at most 1:2.

In some cases, the edible transferable holographic image film is flavorless. In these cases, the edible transferable holographic image film can be used to provide a food product with unaltered flavor and a holographic image on a first surface.

In some cases, the edible transferable holographic image film includes a flavorant. In these cases, the flavorant can optionally be introduced by inclusion in a silk fibroin solution used in making the edible transferable holographic image film. In these cases, the edible transferable holographic image film can be used to provide a food product with enhanced flavor and a holographic image on the first surface.

In some cases, the edible transferable holographic image film includes a colorant. In these cases, the colorant can optionally be introduced by inclusion in a silk fibroin solution used in making the edible transferable holographic image film. The colorant can be any food safe colorant. In some cases, the colorant is a pigment or a dye. The colorant can impact the appearance of the holographic image.

In some cases, the edible transferable holographic image film includes one or more nutritional supplements, including but not limited to vitamins. In these cases, the edible transferable holographic image film can impact the nutritional content of the food product.

The food product can be a chip. The food product can be a potato chip.

The edible transferable holographic image film can be transferred on the surface of any solid food or can be deposited on the liquid-air interface of any food that is originally liquid and solidifies over time. The food can be raw, partially cooked, fully cooked, or frozen.

Examples of food products include, but are not limited to, fruits and vegetables, meat, seafood, fish, baking goods, and the like.

An example food product has an edible transferable holographic image film on at least one surface of the food product. The edible transferable holographic image film can be tuned to endure certain conditions, such as certain temperature and humidity conditions, to which the food product is exposed. Tuning the edible transferable holographic image film may involve varying a degree of beta-sheet crystallinity.

Certain further aspects of the example food product are described following, any one or more of which may be present in certain embodiments. The edible transferable holographic image film of the example food product may include silk fibroin in an amount by weight of at least 50%, at least 60%, at least 70%, at least 80%, at least 90%, or 100%. The edible transferable holographic image film may have a total thickness of between 5 μm and 50 μm. The edible transferable holographic image film may have a holographic image pattern on a first film surface and a non-patterned substrate portion. The holographic image pattern may have an image pattern thickness of between 150 nm and 3 μm. The holographic image pattern may have lateral image feature dimensions of between 150 nm and 5 μm. The non-patterned substrate portion of the edible transferable holographic image film may have a substrate thickness of between 4.85 μm and 49.85 μm. The edible transferable holographic image film of the example food product may have a degree of beta-sheet crystallinity that is tuned to sustain the holographic image pattern through exposure to a temperature exceeding 40 °C and/or a relative humidity exceeding 95% for at least an exposure length of time. The exposure length of time may be between 2 hours and 24 hours. The example food product may be at least one of a chip, a potato chip, a fruit, a vegetable, a meat, a seafood, a fish, a baked good, raw, cooked, partially cooked, or frozen.

The present disclosure provides an edible transferable holographic image film. Unless expressly indicated otherwise, features described elsewhere herein relating to the edible transferable holographic image film in other contexts (e.g., in the context of a food product or a method) are applicable here to the edible transferable holographic image film and vice versa.

The present disclosure provides a method of making an edible transferable holographic image film. As a first method step, the method includes cast molding a silk fibroin solution onto a holographic image mold. As a second method step, the method includes, during or after the cast molding, tuning a degree of beta-sheet crystallinity in the edible transferable holographic image film. The degree of beta-sheet crystallinity is tuned as described elsewhere herein to sustain, or enable the endurance of, the edible transferable holographic image film through various conditions as described elsewhere herein. As a third method step, the method includes removing the edible transferable holographic image film from the holographic image mold. Removing the edible transferable holographic image film from the holographic image mold and applying it to a food product produces an image fidelity of at least 90%. In some cases, the image fidelity is at least 95%. In some cases, the image fidelity is at least 98%. In some cases, the image fidelity is at least 99%.

An example method may include making an edible transferable holographic image film. The example method may include cast molding a silk fibroin solution onto a holographic image mold, the silk fibroin solution having a silk fibroin concentration by weight of between 0.01% and 1%, the holographic image mold having a depth dimension of between 150 nm and 3 μm and lateral dimensions of between 150 nm and 5 μm, thereby forming the edible transferable holographic image film within the mold. The edible transferable holographic image film may include a holographic image pattern on a first film surface and a non-patterned substrate portion. An amount of silk fibroin solution may be tailored to produce a total thickness of between 5 μm and 50 μm for the edible transferable holographic image film, an image pattern thickness of between 150 nm and 3 μm and lateral image feature dimensions of between 150 nm and 5 μm for the holographic image pattern, and a substrate thickness of between 4.85 μm and 49.85 μm for the non-patterned substrate thickness. The example method may further include, during or after the cast molding, tuning a degree of beta sheet crystallinity in the edible transferable holographic image film to sustain the holographic image pattern through exposure to a temperature exceeding 40 °C and/or a relative humidity exceeding 95% for at least an exposure length of time. The holographic image pattern may endure exposure for a length of time that may be between 2 hours and 24 hours. The example method may further include removing the edible transferable holographic image film from the holographic image mold, wherein removing the edible transferable holographic image film from the holographic image mold and applying it to a food product produces an image fidelity of at least 90%, at least 95%, at least 98%, or at least 99%.

An example edible transferable holographic image film may include a holographic image pattern on a first film surface and a non-patterned substrate portion. The edible transferable holographic image film may include silk fibroin in an amount by weight of at least 50%, at least 60%, at least 70%, at least 80%, at least 90%, or 100%. The edible transferable holographic image film may have a total thickness of between 5 μm and 50 μm. The holographic image pattern may have an image pattern thickness of between 150 nm and 3 μm. The holographic image pattern may have lateral image feature dimensions of between 150 nm and 5 μm. The non-patterned substrate portion may have a substrate thickness of between 4.85 μm and 49.85 μm. The edible transferable holographic image film may have a degree of beta-sheet crystallinity that is tuned to sustain the holographic image pattern through exposure to a temperature exceeding 40 °C and/or a relative humidity exceeding 95% for at least an exposure length of time. The exposure length of time may be between 2 hours and 24 hours.

The holographic image mold has a depth dimension of between 150 nm and 3 μm and lateral dimensions of between 150 nm and 5 μm.

The present disclosure provides a method of using an edible transferable holographic image film. The method includes applying a first instance of the edible transferable holographic image film to a first surface of a food product. In some cases where the surface is not particularly flat over long areas, the method can include applying a second instance of the edible transferable holographic image film to a second surface of the food product. As an example, wavy potato chips include various surfaces that are not flat relative to one another. Strips of the edible transferable holographic image film could be applied to different sides of the waves, thereby providing a holographic image across the entire wavey surface.

Without wishing to be bound by any particular theory, it is believed that the hydration state of the food product surfaces can have a significant impact on edible transferable holographic image film performance. In instances where the surface is wet upon application, the edible transferable holographic image film needs to be properly tailored to be insoluble prior to application. In instances where the surface is dry upon application, the edible transferable holographic image film may need to have moisture added for adhesion (e.g., applying in a high humidity environment or prewetting the food surface).

In some cases, the first surface is wet and the edible transferable holographic image film is annealed prior to applying the first instance to the first surface. In some cases, the second (third, fourth, nth, etc.) surface is wet and the edible transferable holographic image film is annealed prior to applying the second (third, fourth, nth, etc.) instance to the second (third, fourth, nth, etc.) surface.

The present disclosure provides a method of making an edible holographic image-providing powder. The method includes sub-dividing the edible transferable holographic image film disclosed elsewhere herein. The sub-dividing can be achieved by conventional means, such as ball milling.

The present disclosure provides an edible holographic image-providing powder. The powder includes particles of the edible transferable holographic image film as described herein and correspondingly includes the various properties of the edible transferable holographic image film as described herein, unless the context clearly dictates otherwise.

The present disclosure provides an edible film having embedded therein the holographic image-providing powder. The edible film can itself be made of silk fibroin or another edible material (e.g., gelatin).

Disclosed herein are applications of, and methods utilizing, the disclosed edible films and powders. In embodiments, edible films and powders described herein may be holographic or non-holographic. Some embodiments of the edible films and powders may provide optical qualities such as color, fluorescence, etc. Taking advantage of the holographic and/or non-holographic properties of the edible films and powders disclosed herein, in embodiments, the edible films may be used in a regulatory or security application, such as to provide a physical representation of a food certification, an authenticity of origin or source, an anti-tampering or authenticity indication, or to provide some aspect of security for a consumable. For example, the edible film may provide a durable physical representation of a certificate of origin of a specialty or exotic fruit, a transparency or traceability indication of animal welfare standards used in meats for sale, an indication of GMO best practices used in a harvested consumable, an indication of authenticity of a non-lab grown food source, and the like. In some examples, the edible films and powders may provide an indication of versions or doses of consumables that bear certain possession restrictions, versus versions or doses of those consumables having a medical exemption or other unrestricted or exempted use. In embodiments, the edible films may be used in a two-factor authentication application, such as by using an aspect of the film to gain access to a restricted website (e.g., a forum to gain restricted access to additional inventory of a specialty consumable). In embodiments, the edible films may be used to provide an optically-based physically unclonable function.

In embodiments, the edible films and powders may be used in a regulatory or security application such as to provide a dynamic indication of a food certification, an authenticity or certificate of origin or source, an anti-tampering or authenticity indication, or to provide some aspect of security for a consumable. In these embodiments, the edible films and powders may possess certain physical characteristics in place of or in addition to optical properties that may be dynamically triggered or leveraged for the disclosed applications. In some embodiments, the edible films may have multiple triggers to provide dynamic indications/representations. For example, the edible film may be designed to persist for a certain duration then degrade or undergo an alteration after a certain time or upon a trigger, such as exposure to air, water, smoke, light, microbes, temperature, humidity, biological fluids, or some other agent/reagent. For example, an edible film may be applied to certain meats to provide an authentication that it is not lab-grown, imitation meat. The edible film may degrade upon reaching a threshold temperature or upon coming into contact with a liquid. In another example, an edible film applied to a toothbrush bristle may undergo a color alteration upon initial use allowing users to know the toothbrush is in use, then may undergo timed degradation during extended use of the toothbrush.

Disclosed herein are films and powders that may be used to provide a dynamic security function. For example, the disclosed films may be applied to single-use items, such as hospital tubing or syringes, to provide assurance that the item has not already been used. In examples, the films may alter or degrade upon first use, as previously described herein, thus providing a dynamic indication of use.

In any of the aforementioned embodiments, the disclosed films may be conformally applied to a surface. In some examples, the edible film may be formed into a roll of film to be distributed in pre-apportioned or custom sizes.

In any of the aforementioned embodiments, the disclosed films and powders may be transferred within a portion/layer of an item.

In embodiments, the films may be lenticularly printed to provide an image with an optical illusion.

In any of the aforementioned embodiments, the disclosed films and powders may also provide an aesthetic embellishment, or a branding function. For example, embodiments may include edible glitter. The edible glitter may form part of the dynamic or durable security films described herein, or the edible glitter itself may also provide a security function such as by possessing the dynamic characteristics of degradation and/or alteration described herein.

Disclosed herein is a product (e.g., medicament, a nutraceutical, a supplement, cannabis edible) having an edible transferable image film on at least one surface of the product, the edible transferable image film comprising silk fibroin in an amount by weight of at least 50%, at least 60%, at least 70%, at least 80%, at least 90%, or 100%. The edible transferable image film has a total thickness of between 5 μm and 50 μm, and has an image pattern on a first film surface and a non-patterned substrate portion, wherein the image pattern has an image pattern thickness of between 150 nm and 3 μm and lateral image feature dimensions of between 150 nm and 5 μm. The non-patterned substrate portion has a substrate thickness of between 4.85 μm and 49.85 μm. The edible transferable image film has a degree of beta-sheet crystallinity that is tuned to sustain the image pattern through exposure to a temperature exceeding 40 °C and/or a relative humidity exceeding 95% for at least an exposure length of time, wherein the exposure length of time is between 2 hours and 24 hours. The edible transferable image film is configured to degrade or undergo an alteration after at least one of a passage of time or a trigger, such as an exposure to at least one of air, water, smoke, light, microbes, temperature, humidity, biological fluids, an agent, or a reagent. In some embodiments, the product is supplied as a roll.

Disclosed herein is a method of providing at least one of a regulatory feature or a security feature for a consumable product using an edible transferable image film made by the method of any one of the preceding claims, the method comprising applying a first instance of the edible transferable image film to a first surface of the consumable product. The regulatory feature is at least one of a food certification, an authenticity of origin or source, a transparency or traceability indication of animal welfare standards, a restricted use product, or an anti-tampering or authenticity indication. The security feature is at least one of a two-factor authentication application or an optically-based physically unclonable function. The edible transferable image film is configured to degrade or undergo an alteration after at least one of a passage of time or a trigger, wherein the trigger is an exposure to at least one of air, water, smoke, light, microbes, temperature, humidity, biological fluids, an agent, or a reagent.

Disclosed herein is a method of providing at least one of a regulatory feature or a security feature, described elsewhere herein, for a consumable product using an edible transferable holographic image film made by the method of any one of the preceding claims, the method comprising applying a first instance of the edible transferable holographic image film to a first surface of the consumable product. The edible transferable holographic image film is configured to degrade or undergo an alteration after at least one of a passage of time or a trigger, such as those described elsewhere herein.

Disclosed herein is a food product, such as those described herein, having an edible transferable image film on at least one surface of the food product, the edible transferable image film comprising silk fibroin in an amount by weight of at least 50%, at least 60%, at least 70%, at least 80%, at least 90%, or 100%, the edible transferable image film having an image pattern on a first film surface and a non-patterned substrate portion, wherein the edible transferable image film has a total thickness of between 5 μm and 50 μm, wherein the image pattern has an image pattern thickness of between 150 nm and 3 μm, wherein the image pattern has lateral image feature dimensions of between 150 nm and 5 μm, wherein the non-patterned substrate portion has a substrate thickness of between 4.85 μm and 49.85 μm, wherein the edible transferable image film has a degree of beta-sheet crystallinity that is tuned to sustain the image pattern through exposure to a temperature exceeding 40 °C and/or a relative humidity exceeding 95% for at least an exposure length of time, wherein the exposure length of time is between 2 hours and 24 hours. The food product may be raw, cooked/partially cooked, or frozen. The exposure length of time is between 4 and 6 hours, between 5 and 8 hours, between 10 and 12 hours, between 4 and 12 hours, between 10 and 18 hours, or between 18 and 24 hours, or at least 3 hours, at least 6 hours, at least 9 hours, at least 12 hours, at least 18 hours, or at most 20 hours, at most 16 hours, at most 12 hours, or at most 10 hours.

Disclosed herein is a method of making an edible transferable image film, the method including cast molding a silk fibroin solution onto an image mold, the silk fibroin solution having a silk fibroin concentration by weight of between 0.01% and 1%, the image mold having a depth dimension of between 150 nm and 3 μm and lateral dimensions of between 150 nm and 5 μm, thereby forming the edible transferable image film within the mold, the edible transferable image film comprising an image pattern on a first film surface and a non-patterned substrate portion, wherein an amount of silk fibroin solution is tailored to produce a total thickness of between 5 μm and 50 μm for the edible transferable image film, an image pattern thickness of between 150 nm and 3 μm and lateral image feature dimensions of between 150 nm and 5 μm for the image pattern, and a substrate thickness of between 4.85 μm and 49.85 μm for the non-patterned substrate thickness. During or after the cast molding, the method includes tuning a degree of beta sheet crystallinity in the edible transferable image film to sustain the image pattern through exposure to a temperature exceeding 40 °C and/or a relative humidity exceeding 95% for at least an exposure length of time, wherein the exposure length of time is between 2 hours and 24 hours, and removing the edible transferable image film from the image mold. Removing the edible transferable image film from the image mold and applying it to a food product produces an image fidelity of at least 90%, at least 95%, at least 98%, or at least 99%.

Disclosed herein is a method of using the edible transferable image film may include applying a first instance of the edible transferable image film to a first surface of a food product.

Disclosed herein is a product having an edible transferable holographic image film on at least one surface of the product, the edible transferable holographic image film comprising silk fibroin in an amount by weight of at least 50%, at least 60%, at least 70%, at least 80%, at least 90%, or 100%, the edible transferable holographic image film having a holographic image pattern on a first film surface and a non-patterned substrate portion, wherein the edible transferable holographic image film has a total thickness of between 5 μm and 50 μm, wherein the holographic image pattern has an image pattern thickness of between 150 nm and 3 μm, wherein the holographic image pattern has lateral image feature dimensions of between 150 nm and 5 μm, wherein the non-patterned substrate portion has a substrate thickness of between 4.85 μm and 49.85 μm, wherein the edible transferable holographic image film has a degree of beta-sheet crystallinity that is tuned to sustain the holographic image pattern through exposure to a temperature exceeding 40 °C and/or a relative humidity exceeding 95% for at least an exposure length of time, wherein the exposure length of time is between 2 hours and 24 hours. The edible transferable holographic image film is configured to degrade or undergo an alteration after at least one of a passage of time or a trigger (e.g., an exposure to at least one of air, water, smoke, light, microbes, temperature, humidity, biological fluids, an agent, or a reagent). The product is at least one of a medicament, a nutraceutical, a supplement, or a cannabis edible, and may be supplied as a roll. The exposure length of time is between 4 and 6 hours, between 5 and 8 hours, between 10 and 12 hours, between 4 and 12 hours, between 10 and 18 hours, or between 18 and 24 hours, or at least 3 hours, at least 6 hours, at least 9 hours, at least 12 hours, at least 18 hours, or at most 20 hours, at most 16 hours, at most 12 hours, or at most 10 hours.

Disclosed herein is a method of providing at least one of a regulatory feature or a security feature, as elsewhere described herein, for a consumable product using an edible transferable holographic image film including applying a first instance of the edible transferable holographic image film to a first surface of the consumable product. The edible transferable holographic image film is configured to degrade or undergo an alteration after at least one of a passage of time or a trigger, as elsewhere described herein.

According to various embodiments, a variety of functionalizing agents may be used with the silk-containing embodiments described herein (e.g., silk membrane, silk composition, silk articles, silk matrix, silk foam, silk microsphere, liquid composition, whipped silk cream, silk meringue, compressed silk meringue, hot-pressed silk meringue, silk leather, silk powder, silk toner, edible silk-based films, etc.). It should be understood that the examples herein may recite one or a few silk-containing embodiments but are applicable to any silk-containing embodiment, as applicable. In some embodiments, a functionalizing agent may be any compound or molecule that facilitates the attachment to and/or development (e.g., growth) of one or more endothelial cells on a silk membrane. In some embodiments, a functionalizing agent may be any compound or molecule that facilitates the attachment and/or development (e.g., growth) of one or more megakaryocytes and/or hematopoietic progenitor cells on a silk matrix and/or silk membrane. In some embodiments, a functionalizing agent may be or comprise an agent suitable for facilitating the production of one or more of white blood cells and red blood cells.

In some embodiments, a functionalizing agent may be or comprise a cell attachment mediator and/or an extracellular matrix protein, for example: collagen (e.g., collagen type I, collagen type III, collagen type IV or collagen type VI), elastin, fibronectin, vitronectin, laminin, fibrinogen, von Willebrand factor, proteoglycans, decorin, perlecan, nidogen, hyaluronan, and/or peptides containing known integrin binding domains e.g. “RGD” integrin binding sequence, or variations thereof, that are known to affect cellular attachment.

In some embodiments, a functionalizing agent may be any soluble molecule produced by endothelial cells. Non-limiting examples include fibroblast growth factor-1 (FGF1) and vascular endothelial growth factors (VEGF).

According to some embodiments, a plurality of functionalizing agents may be used. For example, in some embodiments wherein production of platelets is desired, provided compositions may comprise the use of laminin, fibronectin and/or fibrinogen, and type IV collagen in order to facilitate the attachment and growth of endothelial cells on a silk membrane (e.g., a porous silk membrane) and/or attachment of megakaryocytes to a silk matrix.

In some embodiments, a functionalizing agent may be embedded or otherwise associated with a silk membrane and/or silk matrix such that at least a portion of the functionalizing agent is surrounded by a silk membrane and/or silk matrix as contrasted to a functionalizing agent simply being positioned along the surface of a silk membrane and/or silk matrix. In some embodiments, a functionalizing agent is distributed along and/or incorporated in substantially the entire surface area of a silk membrane/silk wall. In some embodiments, a functionalizing agent is distributed and/or incorporated only at one or more discrete portions of a silk membrane/wall and/or silk matrix. In some embodiments, a functionalizing agent is distributed in and/or along at least one of the lumen-facing side of a silk wall and the matrix-facing side of a silk wall.

According to various embodiments, any application-appropriate amount of one or more functionalizing agents may be used. In some embodiments, the amount of an individual functionalizing agent may be between about 1 μg/ml and 1,000 μg/ml (e.g., between about 2 and 1,000, 5 and 1,000, 10 and 1,000, 10 and 500, 10 and 100 μg/ml). In some embodiments, the amount of an individual functionalizing agent may be at least 1 μg/ml (e.g., at least 5, 10, 15, 20 25, 50, 100, 200, 300 400, 500, 600, 700, 800, or 900 μg/ml). In some embodiments, the amount of an individual functionalizing agent is at most 1,000 μg/ml (e.g., 900, 800, 700, 600, 500, 400, 300 200, 100, 90, 80, 70, 60, 50, 40, 30, 20, 10, or 5 μg/ml).

In some aspects, the composition comprises one or more sensing agents, such as a sensing dye. The sensing agents/sensing dyes are environmentally sensitive and produce a measurable response to one or more environmental factors. In some aspects, the environmentally-sensitive agent or dye may be present in the composition in an effective amount to alter the composition from a first chemical-physical state to a second chemical-physical state in response to an environmental parameter (e.g., a change in pH, light intensity or exposure, temperature, pressure or strain, voltage, physiological parameter of a subject, and/or concentration of chemical species in the surrounding environment) or an externally applied stimulus (e.g., optical interrogation, acoustic interrogation, and/or applied heat). In some cases, the sensing dye is present to provide one optical appearance under one given set of environmental conditions and a second, different optical appearance under a different given set of environmental conditions. Suitable concentrations for the sensing agents described herein can be the concentrations for the colorants and additives described elsewhere herein. A person having ordinary skill in the chemical sensing arts can determine a concentration that is appropriate for use in a sensing application of the inks described herein.

In some aspects, the first and second chemical-physical state may be a physical property of the composition, such as mechanical property, a chemical property, an acoustical property, an electrical property, a magnetic property, an optical property, a thermal property, a radiological property, or an organoleptic property. Exemplary sensing dyes or agents include, but are not limited to, a pH sensitive agent, a thermal sensitive agent, a pressure or strain sensitive agent, a light sensitive agent, or a potentiometric agent.

Exemplary pH sensitive dyes or agents include, but are not limited to, cresol red, methyl violet, crystal violet, ethyl violet, malachite green, methyl green, 2-(p-dimethylaminophenylazo) pyridine, paramethyl red, metanil yellow, 4-phenylazodiphenylamine, thymol blue, metacresol purple, orange IV, 4-o-Tolylazo-o-toluindine, quinaldine red, 2,4-dinitrophenol, erythrosine disodium salt, benzopurpurine 4B, N,N-dimethyl-p-(m-tolylazo) aniline, p-dimethylaminoazobenene, 4,4′-bis(2-amino-1-naphthylazo)-2,2′-stilbenedisulfonic acid, tetrabromophenolphthalein ethyl ester, bromophenol blue, Congo red, methyl orange, ethyl orange, 4-(4-dimethylamino-1-naphylazo)-3-methoxybenesulfonic acid, bromocresol green, resazurin, 4-phenylazo-1-napthylamine, ethyl red 2-(1-dimethylaminophenyazo) pyridine, 4-(p-ethoxypehnylazo)-m-phenylene-diamine monohydrochloride, resorcin blue, alizarin red S, methyl red, propyl red, bromocresol purple, chlorophenol red, p-nitrophenol, alizarin 2-(2,4-dinitrophenylazo) 1-napthol-3,6-disulfonic acid, bromothymol blue, 6,8-dinitro-2,4-(1H) quinazolinedione, brilliant yellow, phenol red, neutral red, m-nitrophenol, cresol red, turmeric, metacresol purple, 4,4′-bis(3-amino-1-naphthylazo)-2,2′-stilbenedisulfonic acid, thymol blue, p-naphtholbenzein, phenolphthalein, o-cresolphthalein, ethyl bis(2,4-dimethylphenyl) ethanoate, thymolphthalein, nitrazine yellow, alizarin yellow R, alizarin, p-(2,4-dihydroxyphenylazo) benzenesulfonic acid, 5,5′-indigodisulfonic acid, 2,4,6-trinitrotoluene, 1,3,5-trinitrobenezne, and clayton yellow.

Exemplary light responsive dyes or agents include, but are not limited to, photochromic compounds or agents, such as triarylmethanes, stilbenes, azasilbenes, nitrones, fulgides, spiropyrans, napthopyrans, spiro-oxzines, quinones, derivatives and combinations thereof.

Exemplary potentiometric dyes include, but are not limited to, substituted amiononaphthylehenylpridinium (ANEP) dyes, such as di-4-ANEPPS, di-8-ANEPPS, and N-(4-Sulfobutyl)-4-(6-(4-(Dibutylamino)phenyl)hexatrienyl)Pyridinium (RH237).

Exemplary temperature sensitive dyes or agents include, but are not limited to, thermochromic compounds or agents, such as thermochromic liquid crystals, leuco dyes, fluoran dyes, octadecylphosphonic acid.

Exemplary pressure or strain sensitive dyes or agents include, but are not limited to, spiropyran compounds and agents.

Exemplary chemi-sensitive dyes or agents include, but are not limited to, antibodies such as immunoglobulin G (IgG) which may change color from blue to red in response to bacterial contamination.

In some aspects, the compositions comprise one or more additive, dopant, or biologically active agent suitable for a desired intended purpose. In some aspects, the additive or dopant may be present in the composition in an amount effective to impart an optical or organoleptic property to the composition. Exemplary additives or dopants that impart optical or organoleptic properties include, but are not limited to, dyes/pigments, flavorants, aroma compounds, granular or fibrous fillers.

Additionally or alternatively, the additive, dopant, or biologically active agent may be present in the composition in an amount effective to “functionalize” the composition to impart a desired mechanical property or added functionality to the composition. Exemplary additive, dopants, or biologically active agent that impart the desired mechanical property or added functionality include, but are not limited to: environmentally sensitive/sensing dyes; active biomolecules; conductive or metallic particles; micro and nanofibers (e.g., silk nanofibers for reinforcement, carbon nanofibers); nanotubes; inorganic particles (e.g., hydroxyapatite, tricalcium phosphate, bioglasses); drugs (e.g., antibiotics, small molecules or low molecular weight organic compounds); proteins and fragments or complexes thereof (e.g., enzymes, antigens, antibodies and antigen-binding fragments thereof); DNA/RNA (e.g., siRNA, miRNA, mRNA); cells and fractions thereof (viruses and viral particles; prokaryotic cells such as bacteria; eukaryotic cells such as mammalian cells and plant cells; fungi).

In some aspects, the additive or dopant comprises a flavoring agent or flavorant.

Exemplary flavorants include ester flavorants, amino acid flavorants, nucleic acid flavorants, organic acid flavorants, and inorganic acid flavorants, such as, but not limited to, diacetyl, acetylpropionyl, acetoin, isoamyl acetate, benzaldehyde, cinnamaldehyde, ethyl propionate, methyl anthranilate, limonene, ethyl decadienoate, allyl hexanoate, ethyl maltol, ethylvanillin, methyl salicylate, manzanate, glutamic acid salts, glycine salts, guanylic acids salts, inosinic acid salts, acetic acid, ascorbic acid, citric acid, fumaric acid, lactic acid, malic acid, phosphoric acid, tartaric acid, derivatives, and mixtures thereof.

In some aspects, the additive or dopant comprises an aroma compound. Exemplary aroma compounds include ester aroma compounds, terpene aroma compounds, cyclic terpenes, and aromatic aroma compounds, such as, but not limited to, geranyl acetate, methyl formate, metyl acetate, methyl propionate, methyl butyrate, ethyl acetate, ethyl butyrate, isoamyl acetate, pentyl butrate, pentyl pentanoate, octyl acetate, benzyl acetate, methyl anthranilate, myrecene, geraniol, nerol, citral, cironellal, cironellol, linalool, nerolidol, limonene, camphor, menthol, carone, terpineol, alpha-lonone, thujone, eucalyptol, benzaldehyde, eugenol, cinnamaldehyde, ethyl maltol, vanillin, anisole, anethole, estragole, thymol.

In some aspects, the additive or dopant comprises a colorant, such as a dye or pigment. In some aspects, the dye or pigment imparts a color or grayscale to the composition. The colorant can be different than the sensing agents and/or sensing dyes below. Any organic and/or inorganic pigments and dyes can be included in the inks. Exemplary pigments suitable for use in the present disclosure include International Color Index or C.I. Pigment Black Numbers 1, 7, 11 and 31, C.I. Pigment Blue Numbers 15, 15:1, 15:2, 15:3, 15:4, 15:6, 16, 27, 29, 61 and 62, C.I. Pigment Green Numbers 7, 17, 18 and 36, C.I. Pigment Orange Numbers 5, 13, 16, 34 and 36, C.I. Pigment Violet Numbers 3, 19, 23 and 27, C.I. Pigment Red Numbers 3, 17, 22, 23, 48:1, 48:2, 57:1, 81:1, 81:2, 81:3, 81:5, 101, 114, 122, 144, 146, 170, 176, 179, 181, 185, 188, 202, 206, 207, 210 and 249, C.I. Pigment Yellow Numbers 1, 2, 3, 12, 13, 14, 17, 42, 65, 73, 74, 75, 83, 30, 93, 109, 110, 128, 138, 139, 147, 142, 151, 154 and 180, D&C Red No. 7, D&C Red No. 6 and D&C Red No. 34, carbon black pigment (such as Regal 330, Cabot Corporation), quinacridone pigments (Quinacridone Magenta (228-0122), available from Sun Chemical Corporation, Fort Lee, N.J.), diarylide yellow pigment (such as AAOT Yellow (274-1788) available from Sun Chemical Corporation); and phthalocyanine blue pigment (such as Blue 15:3 (294-1298) available from Sun Chemical Corporation). The classes of dyes suitable for use in present invention can be selected from acid dyes, natural dyes, direct dyes (either cationic or anionic), basic dyes, and reactive dyes. The acid dyes, also regarded as anionic dyes, are soluble in water and mainly insoluble in organic solvents and are selected, from yellow acid dyes, orange acid dyes, red acid dyes, violet acid dyes, blue acid dyes, green acid dyes, and black acid dyes. European Patent 745651, incorporated herein by reference, describes a number of acid dyes that are suitable for use in the present disclosure. Exemplary yellow acid dyes include Acid Yellow 1 International Color Index or C.I. 10316); Acid Yellow 7 (C.I. 56295); Acid Yellow 17 (C.I. 18965); Acid Yellow 23 (C.I. 19140); Acid Yellow 29 (C.I. 18900); Acid Yellow 36 (C.I. 13065); Acid Yellow 42 (C.I. 22910); Acid Yellow 73 (C.I. 45350); Acid Yellow 99 (C.I. 13908); Acid Yellow 194; and Food Yellow 3 (C.I. 15985). Exemplary orange acid dyes include Acid Orange 1 (C.I. 13090/1); Acid Orange 10 (C.I. 16230); Acid Orange 20 (C.I. 14603); Acid Orange 76 (C.I. 18870); Acid Orange 142; Food Orange 2 (C.I. 15980); and Orange B.

Exemplary red acid dyes include Acid Red 1. (C.I. 18050); Acid Red 4 (C.I. 14710); Acid Red 18 (C.I. 16255), Acid Red 26 (C.I. 16150); Acid Red 2.7 (C.I. as Acid Red 51 (C.I. 45430, available from BASF Corporation, Mt. Olive, N.J.) Acid Red 52 (C.I. 45100); Acid Red 73 (C.I. 27290); Acid Red 87 (C. I. 45380); Acid Red 94 (C.I. 45440) Acid Red 194; and Food Red 1 (C.I. 14700). Exemplary violet acid dyes include Acid Violet 7 (C.I. 18055); and Acid Violet 49 (C.I. 42640). Exemplary blue acid dyes include Acid Blue 1 (C.I. 42045); Acid Blue 9 (C.I. 42090); Acid Blue 22 (C.I. 42755); Acid Blue 74 (C.I. 73015); Acid Blue 93 (C.I. 42780); and Acid Blue 158A (C.I. 15050). Exemplary green acid dyes include Acid Green 1 (C.I. 10028); Acid Green 3 (C.I. 42085); Acid Green 5 (C.I. 42095); Acid Green 26 (C.I. 44025); and Food Green 3 (C.I. 42053). Exemplary black acid dyes include Acid Black 1 (C.I. 20470); Acid Black 194 (Basantol® X80, available from BASF Corporation, an azo/1:2 CR-complex.

Exemplary direct dyes for use in the present disclosure include Direct Blue 86 (C.I. 74180); Direct Blue 199; Direct Black 168; Direct Red 253; and Direct Yellow 107/132 (C.I. Not Assigned).

Exemplary natural dyes for use in the present disclosure include Alkanet (C.I. 75520,75530); Annafto (C.I. 75120); Carotene (C.I. 75130); Chestnut; Cochineal (C.I. 75470); Cutch (C.I. 75250, 75260); Divi-Divi; Fustic (C.I. 75240); Hypernic (C.I. 75280); Logwood (C.I. 75200); Osage Orange (C.I. 75660); Paprika; Quercitron (C.I. 75720); Sanrou (C.I. 75100); Sandal Wood (C.I. 75510, 75540, 75550, 75560); Sumac; and Tumeric (C.I. 75300). Exemplary reactive dyes for use in the present disclosure include Reactive Yellow 37 (monoazo dye); Reactive Black 31 (disazo dye); Reactive Blue 77 (phthalo cyanine dye) and Reactive Red 180 and Reactive Red 108 dyes. Suitable also are the colorants described in The Printing Ink Manual (5th ed., Leach et al. eds. (2007), pages 289-299. Other organic and inorganic pigments and dyes and combinations thereof can be used to achieve the colors desired.

In addition to or in place of visible colorants, compositions provided herein can contain ETV fluorophores that are excited in the ETV range and emit light at a higher wavelength (typically 400 nm and above). Examples of ETV fluorophores include but are not limited to materials from the coumarin, benzoxazole, rhodamine, napthalimide, perylene, benzanthrones, benzoxanthones or benzothia-xanthones families. The addition of a UV fluorophore (such as an optical brightener for instance) can help maintain maximum visible light transmission. The amount of colorant, when present, generally is between 0.05% to 5% or between 0.1% and 1% based on the weight of the composition.

For non-white compositions, the amount of pigment/dye generally is present in an amount of from at or about 0.1 wt % to at or about 20 wt % based on the weight of the composition. In some applications, a non-white ink can include 15 wt % or less pigment/dye, or 10 wt % or less pigment/dye or 5 wt % pigment/dye, or 1 wt % pigment/dye based on the weight of the composition. In some applications, a non-white ink can include 1 wt % to 10 wt %, or 5 wt % to 15 wt %, or 10 wt % to 20 wt % pigment/dye based on the weight of the composition. In some applications, a non-white ink can contain an amount of dye/pigment that is 1 wt %, 2 wt %, 3 wt %, 4 wt %, 5%, 6 wt %, 7 wt %, 8 wt %, 9 wt %, 10 wt %, 11 wt %, 12 wt %, 13 wt %, 14 wt %, 15%, 16 wt %, 17 wt %, 18 wt %, 19 wt % or 20 wt % based on the weight of the composition.

For white compositions, the amount of white pigment generally is present in an amount of from at or about 1 wt % to at or about 60 wt % based on the weight of the composition. In some applications, greater than 60 wt % white pigment can be present. Preferred white pigments include titanium dioxide (anatase and rutile), zinc oxide, lithopone (calcined coprecipitate of barium sulfate and zinc sulfide), zinc sulfide, blanc fixe and alumina hydrate and combinations thereof, although any of these can be combined with calcium carbonate. In some applications, a white ink can include 60 wt % or less white pigment, or 55 wt % or less white pigment, or 50 wt % white pigment, or 45 wt % white pigment, or 40 wt % white pigment, or 35 wt % white pigment, or 30 wt % white pigment, or 25 wt % white pigment, or 20 wt % white pigment, or 15 wt % white pigment, or 10 wt % white pigment, based on the weight of the composition. In some applications, a white ink can include 5 wt % to 60 wt %, or 5 wt % to 55 wt %, or 10 wt % to 50 wt %, or 10 wt % to 25 wt %, or 25 wt % to 50 wt %, or 5 wt % to 15 wt %, or 40 wt % to 60 wt % white pigment based on the weight of the composition. In some applications, a non-white ink can an amount of dye/pigment that is 5%, 6 wt %, 7 wt %, 8 wt %, 9 wt %, 10 wt %, 11 wt %, 12 wt %, 13 wt %, 14 wt %, 15%, 16 wt %, 17 wt %, 18 wt %, 19 wt %, 20 wt %, 21 wt %, 22 wt %, 23 wt %, 24 wt %, 25%, 26 wt %, 27 wt %, 28 wt %, 29 wt %, 30 wt %, 31 wt %, 32 wt %, 33 wt %, 34 wt %, 35%, 36 wt %, 37 wt %, 38 wt %, 39 wt %, 40 wt %, 41 wt %, 42 wt %, 43 wt %, 44 wt %, 45%, 46 wt %, 47 wt %, 48 wt %, 49 wt %, 50 wt %, 51 wt %, 52 wt %, 53 wt %, 54 wt %, 55%, 56 wt %, 57 wt %, 58 wt %, 59 wt % or 60 wt % based on the weight of the composition.

In some aspects, the additive or dopant comprises a conductive additive. Exemplary conductive additives include, but are not limited to graphite, graphite powder, carbon nanotubes, and metallic particles or nanoparticles, such as gold nanoparticles. In some aspects, the conductive additive is biocompatible and non-toxic.

In some aspects, the additive is a biologically active agent. The term “biologically active agent” as used herein refers to any molecule which exerts at least one biological effect in vivo. For example, the biologically active agent can be a therapeutic agent to treat or prevent a disease state or condition in a subject. Biologically active agents include, without limitation, organic molecules, inorganic materials, proteins, peptides, nucleic acids (e.g., genes, gene fragments, gene regulatory sequences, and antisense molecules), nucleoproteins, polysaccharides, glycoproteins, and lipoproteins. Classes of biologically active compounds that can be incorporated into the composition provided herein include, without limitation, anticancer agents, antibiotics, analgesics, anti-inflammatory agents, immunosuppressants, enzyme inhibitors, antihistamines, anti-convulsants, hormones, muscle relaxants, antispasmodics, ophthalmic agents, prostaglandins, anti-depressants, anti-psychotic substances, trophic factors, osteoinductive proteins, growth factors, and vaccines.

The term “active agent” may also be used herein to refer to a biological sample (e.g., a sample of tissue or fluid, such as for instance blood) or a component thereof, and/or to a biologically active entity or compound, and/or to a structurally or functionally labile entity.

Exemplary active agents include, but are not limited to, therapeutic agents, diagnostic agents (e.g., contrast agents), and any combinations thereof. In some embodiments, the active agent present in a silk matrix (e.g., a silk microsphere), composition, or the like can include a labile active agent, e.g., an agent that can undergo chemical, physical, or biological change, degradation and/or deactivation after exposure to a specified condition, e.g., high temperatures, high humidity, light exposure, and any combinations thereof. In some embodiments, the active agent present in the silk matrix (e.g., a silk microsphere), composition, or the like can include a temperature-sensitive active agent, e.g., an active agent that will lose at least about 30% or more, of its original activity or bioactivity, upon exposure to a temperature of at least about 10 °C or above, including at least about 15 °C or above, at least about room temperature or above, or at least about body temperature (e.g., about 37 °C) or above.

The active agent can be generally present in the silk matrix (e.g., a silk microsphere), composition, or the like in an amount of about 0.01% (w/w) to about 70% (w/w), or about 0.1% (w/w) to about 50% (w/w), or about 1% (w/w) to about 30% (w/w). The active agent can be present on a surface of the silk matrix (e.g., a silk microsphere), composition, or the like and/or encapsulated and dispersed in the silk matrix (e.g., a silk microsphere), composition, or the like homogeneously or heterogeneously or in a gradient. In some embodiments, the active agent can be added into the silk solution, which is then subjected to the methods described herein for preparing a silk matrix (e.g., a silk microsphere), composition, or the like. In some embodiments, the active agent can be coated on a surface of the silk matrix (e.g., a silk microsphere), composition, or the like. In some embodiments, the active agent can be loaded in a silk matrix (e.g., a silk microsphere), composition, or the like by incubating the silk microsphere in a solution of the active agent for a period of time, during which an amount of the active agent can diffuse into the silk matrix (e.g., a silk microsphere), composition, or the like, and thus distribute within the silk matrix (e.g., a silk microsphere), composition, or the like.

In some aspects, the additive is a therapeutic agent. As used herein, the term “therapeutic agent” means a molecule, group of molecules, complex or substance administered to an organism for diagnostic, therapeutic, preventative medical, or veterinary purposes. As used herein, the term “therapeutic agent” includes a “drug” or a “vaccine.” This term include externally and internally administered topical, localized and systemic human and animal pharmaceuticals, treatments, remedies, nutraceuticals, cosmeceuticals, biologicals, devices, diagnostics and contraceptives, including preparations useful in clinical and veterinary screening, prevention, prophylaxis, healing, wellness, detection, imaging, diagnosis, therapy, surgery, monitoring, cosmetics, prosthetics, forensics and the like. This term can also be used in reference to agriceutical, workplace, military, industrial and environmental therapeutics or remedies comprising selected molecules or selected nucleic acid sequences capable of recognizing cellular receptors, membrane receptors, hormone receptors, therapeutic receptors, microbes, viruses or selected targets comprising or capable of contacting plants, animals and/or humans. This term can also specifically include nucleic acids and compounds comprising nucleic acids that produce a therapeutic effect, for example deoxyribonucleic acid (DNA), ribonucleic acid (RNA), nucleic acid analogues (e.g., locked nucleic acid (LNA), peptide nucleic acid (PNA), xeno nucleic acid (XNA)), or mixtures or combinations thereof, including, for example, DNA nanoplexes, siRNA, microRNA, shRNA, aptamers, ribozymes, decoy nucleic acids, antisense nucleic acids, RNA activators, and the like. Generally, any therapeutic agent can be included in the composition provided herein.

The term “therapeutic agent” also includes an agent that is capable of providing a local or systemic biological, physiological, or therapeutic effect in the biological system to which it is applied. For example, the therapeutic agent can act to control infection or inflammation, enhance cell growth and tissue regeneration, control tumor growth, act as an analgesic, promote anti-cell attachment, and enhance bone growth, among other functions. Other suitable therapeutic agents can include anti-viral agents, hormones, antibodies, or therapeutic proteins. Other therapeutic agents include prodrugs, which are agents that are not biologically active when administered but, upon administration to a subject are converted to biologically active agents through metabolism or some other mechanism. Additionally, a silk-based drug delivery composition can contain one therapeutic agent or combinations of two or more therapeutic agents.

A therapeutic agent can include a wide variety of different compounds, including chemical compounds and mixtures of chemical compounds, e.g., small organic or inorganic molecules; saccharines; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; an extract made from biological materials such as bacteria, plants, fungi, or animal cells; animal tissues; naturally occurring or synthetic compositions; and any combinations thereof. In some aspects, the therapeutic agent is a small molecule.

The term “bioactivity,” as used herein in reference to an active agent, generally refers to the ability of an active agent to interact with a biological target and/or to produce an effect on a biological target. For example, bioactivity can include, without limitation, elicitation of a stimulatory, inhibitory, regulatory, toxic or lethal response in a biological target. The biological target can be a molecule or a cell. For example, a bioactivity can refer to the ability of an active agent to modulate the effect/activity of an enzyme, block a receptor, stimulate a receptor, modulate the expression level of one or more genes, modulate cell proliferation, modulate cell division, modulate cell morphology, or any combination thereof. In some instances, a bioactivity can refer to the ability of a compound to produce a toxic effect in a cell. Exemplary cellular responses include, but are not limited to, lysis, apoptosis, growth inhibition, and growth promotion; production, secretion, and surface expression of a protein or other molecule of interest by the cell; membrane surface molecule activation including receptor activation; transmembrane ion transports; transcriptional regulations; changes in viability of the cell; changes in cell morphology; changes in presence or expression of an intracellular component of the cell; changes in gene expression or transcripts; changes in the activity of an enzyme produced within the cell; and changes in the presence or expression of a ligand and/or receptor (e.g., protein expression and/or binding activity). Methods for assaying different cellular responses are well known to one of skill in the art, e.g., western blot for determining changes in presence or expression of an endogenous protein of the cell, or microscopy for monitoring the cell morphology in response to the active agent, or FISH and/or qPCR for the detection and quantification of changes in nucleic acids. Bioactivity can be determined in some embodiments, for example, by assaying a cellular response.

In reference to an antibody, the term “bioactivity” includes, but is not limited to, epitope or antigen binding affinity, the in vivo and/or in vitro stability of the antibody, the immunogenic properties of the antibody, e.g., when administered to a human subject, and/or the ability to neutralize or antagonize the bioactivity of a target molecule in vivo or in vitro. The aforementioned properties or characteristics can be observed or measured using art-recognized techniques including, but not limited to, scintillation proximity assays, ELISA, ORIGEN immunoassay (IGEN), fluorescence quenching, fluorescence ELISA, competitive ELISA, SPR analysis including, but not limited to, SPR analysis using a BIAcore biosensor, in vitro and in vivo neutralization assays (see, for example, International Publication No. WO 2006/062685), receptor binding, and immunohistochemistry with tissue sections from different sources including human, primate, or any other source as needed. In reference to an immunogen, the “bioactivity” includes immunogenicity, the definition of which is discussed in detail later. In reference to a virus, the “bioactivity” includes infectivity, the definition of which is discussed in detail later. In reference to a contrast agent, e.g., a dye, the “bioactivity” refers to the ability of a contrast agent when administered to a subject to enhance the contrast of structures or fluids within the subject's body. The bioactivity of a contrast agent also includes, but is not limited to, its ability to interact with a biological environment and/or influence the response of another molecule under certain conditions.

As used herein, the term “small molecule” can refer to compounds that are “natural product-like,” however, the term “small molecule” is not limited to “natural product-like” compounds. Rather, a small molecule is typically characterized in that it contains several carbon-carbon bonds, and has a molecular weight of less than 5000 Daltons (5 kDa), preferably less than 3 kDa, still more preferably less than 2 kDa, and most preferably less than 1 kDa. In some cases it is preferred that a small molecule have a molecular weight equal to or less than 700 Daltons.

Exemplary therapeutic agents include, but are not limited to, those found in Harrison's Principles of Internal Medicine, 13th Edition, Eds. T.R. Harrison et al. McGraw-Hill N.Y., NY; Physicians' Desk Reference, 50th Edition, 1997, Oradell New Jersey, Medical Economics Co.; Pharmacological Basis of Therapeutics, 8th Edition, Goodman and Gilman, 1990; United States Pharmacopeia, The National Formulary, ETSP XII NF XVII, 1990, the complete contents of all of which are incorporated herein by reference.

Therapeutic agents include the herein disclosed categories and specific examples. It is not intended that the category be limited by the specific examples. Those of ordinary skill in the art will recognize also numerous other compounds that fall within the categories and that are useful according to the present disclosure. Examples include a radiosensitizer, a steroid, a xanthine, a beta-2-agonist bronchodilator, an anti-inflammatory agent, an analgesic agent, a calcium antagonist, an angiotensin-converting enzyme inhibitors, a beta-blocker, a centrally active alpha-agonist, an alpha-1-antagonist, an anticholinergic/antispasmodic agent, a vasopressin analogue, an anti arrhythmic agent, an antiparkinsonian agent, an antiangina/antihypertensive agent, an anticoagulant agent, an antiplatelet agent, a sedative, an ansiolytic agent, a peptidic agent, a biopolymeric agent, an antineoplastic agent, a laxative, an antidiarrheal agent, an antimicrobial agent, an antifungal agent, a vaccine, a protein, or a nucleic acid. In a further aspect, the pharmaceutically active agent can be coumarin, albumin, steroids such as betamethasone, dexamethasone, methylprednisolone, prednisolone, prednisone, triamcinolone, budesonide, hydrocortisone, and pharmaceutically acceptable hydrocortisone derivatives; xanthines such as theophylline and doxophylline; beta-2-agonist bronchodilators such as salbutamol, fenterol, clenbuterol, bambuterol, salmeterol, fenoterol; antiinflammatory agents, including antiasthmatic anti-inflammatory agents, antiarthritis antiinflammatory agents, and non-steroidal antiinflammatory agents, examples of which include but are not limited to sulfides, mesalamine, budesonide, salazopyrin, diclofenac, pharmaceutically acceptable diclofenac salts, nimesulide, naproxene, acetaminophen, ibuprofen, ketoprofen and piroxicam; analgesic agents such as salicylates; calcium channel blockers such as nifedipine, amlodipine, and nicardipine; angiotensin converting enzyme inhibitors such as captopril, benazepril hydrochloride, fosinopril sodium, trandolapril, ramipril, lisinopril, enalapril, quinapril hydrochloride, and moexipril hydrochloride; beta-blockers (i.e., beta adrenergic blocking agents) such as sotalol hydrochloride, timolol maleate, esmolol hydrochloride, carteolol, propanolol hydrochloride, betaxolol hydrochloride, penbutolol sulfate, metoprolol tartrate, metoprolol succinate, acebutolol hydrochloride, atenolol, pindolol, and bisoprolol fumarate; centrally active alpha-2-agonists such as clonidine; alpha-1-antagonists such as doxazosin and prazosin; anticholinergic/antispasmodic agents such as dicyclomine hydrochloride, scopolamine hydrobromide, glycopyrrolate, clidinium bromide, flavoxate, and oxybutynin; vasopressin analogues such as vasopressin and desmopressin; antiarrhythmic agents such as quinidine, lidocaine, tocainide hydrochloride, mexiletine hydrochloride, digoxin, verapamil hydrochloride, propafenone hydrochloride, flecainide acetate, procainamide hydrochloride, moricizine hydrochloride, and disopyramide phosphate; antiparkinsonian agents, such as dopamine, L-Dopa/Carbidopa, selegiline, dihydroergocryptine, pergolide, lisuride, apomorphine, and bromocryptine; antiangina agents and antihypertensive agents such as isosorbide mononitrate, isosorbide dinitrate, propranolol, atenolol and verapamil; anticoagulant and antiplatelet agents such as Coumadin, warfarin, acetylsalicylic acid, and ticlopidine; sedatives such as benzodiazepines and barbiturates; ansiolytic agents such as lorazepam, bromazepam, and diazepam; peptidic and biopolymeric agents such as calcitonin, leuprolide and other LHRH agonists, hirudin, cyclosporin, insulin, somatostatin, protirelin, interferon, desmopressin, somatotropin, thymopentin, pidotimod, erythropoietin, interleukins, melatonin, granulocyte/macrophage-CSF, and heparin; antineoplastic agents such as etoposide, etoposide phosphate, cyclophosphamide, methotrexate, 5-fluorouracil, vincristine, doxorubicin, cisplatin, hydroxyurea, leucovorin calcium, tamoxifen, flutamide, asparaginase, altretamine, mitotane, and procarbazine hydrochloride; laxatives such as senna concentrate, casanthranol, bisacodyl, and sodium picosulphate; antidiarrheal agents such as difenoxine hydrochloride, loperamide hydrochloride, furazolidone, diphenoxylate hdyrochloride, and microorganisms; vaccines such as bacterial and viral vaccines; antimicrobial agents such as penicillins, cephalosporins, and macrolides, antifungal agents such as imidazolic and triazolic derivatives; and nucleic acids such as DNA sequences encoding for biological proteins, and antisense oligonucleotides.

Anti-cancer agents include alkylating agents, platinum agents, antimetabolites, topoisomerase inhibitors, antitumor antibiotics, antimitotic agents, aromatase inhibitors, thymidylate synthase inhibitors, DNA antagonists, farnesyltransferase inhibitors, pump inhibitors, histone acetyltransferase inhibitors, metalloproteinase inhibitors, ribonucleoside reductase inhibitors, TNF alpha agonists/antagonists, endothelinA receptor antagonists, retinoic acid receptor agonists, immuno-modulators, hormonal and antihormonal agents, photodynamic agents, and tyrosine kinase inhibitors.

Antibiotics include aminoglycosides (e.g., gentamicin, tobramycin, netilmicin, streptomycin, amikacin, neomycin), bacitracin, corbapenems (e.g., imipenem/cislastatin), cephalosporins, colistin, methenamine, monobactams (e.g., aztreonam), penicillins (e.g., penicillin G, penicillin V, methicillin, natcillin, oxacillin, cloxacillin, dicloxacillin, ampicillin, amoxicillin, carbenicillin, ticarcillin, piperacillin, mezlocillin, azlocillin), polymyxin B, quinolones, and vancomycin; and bacteriostatic agents such as chloramphenicol, clindanyan, macrolides (e.g., erythromycin, azithromycin, clarithromycin), lincomyan, nitrofurantoin, sulfonamides, tetracyclines (e.g., tetracycline, doxycycline, minocycline, demeclocyline), and trimethoprim. Also included are metronidazole, fluoroquinolones, and ritampin.

Enzyme inhibitors are substances which inhibit an enzymatic reaction. Examples of enzyme inhibitors include edrophonium chloride, N-methylphysostigmine, neostigmine bromide, physostigmine sulfate, tacrine, tacrine, 1-hydroxy maleate, iodotubercidin, p-bromotetramiisole, 10-(alpha-diethylaminopropionyl)-phenothiazine hydrochloride, calmidazolium chloride, hemicholinium-3,3,5-dinitrocatechol, diacylglycerol kinase inhibitor I, diacylglycerol kinase inhibitor II, 3-phenylpropargylamine, N°-monomethyl-Larginine acetate, carbidopa, 3-hydroxybenzylhydrazine, hydralazine, clorgyline, deprenyl, hydroxylamine, iproniazid phosphate, 6-MeO-tetrahydro-9H-pyrido-indole, nialamide, pargyline, quinacrine, semi carb azide, tranylcypromine, N,N-diethylaminoethyl-2,2-diphenylvalerate hydrochloride, 3-isobutyl-1-methylxanthne, papaverine, indomethacind, 2-cyclooctyl-2-hydroxy ethylamine hydrochloride, 2,3-dichloro-a-methylbenzylamine (DCMB), 8,9-dichloro-2,3,4,5-tetrahydro-1H-2-benzazepine hydrochloride, p-amino glutethimide, p-aminoglutethimide tartrate, 3-iodotyrosine, alpha-methyltyrosine, acetazolamide, dichlorphenamide, 6-hydroxy-2-benzothiazolesulfonamide, and allopurinol.

Antihistamines include pyrilamine, chlorpheniramine, and tetrahydrazoline, among others.

Anti-inflammatory agents include corticosteroids, nonsteroidal anti-inflammatory drugs (e.g., aspirin, phenylbutazone, indomethacin, sulindac, tolmetin, ibuprofen, piroxicam, and fenamates), acetaminophen, phenacetin, gold salts, chloroquine, D-Penicillamine, methotrexate colchicine, allopurinol, probenecid, and sulfinpyrazone.

Muscle relaxants include mephenesin, methocarbomal, cyclobenzaprine hydrochloride, trihexylphenidyl hydrochloride, levodopa/carbidopa, and biperiden.

Anti-spasmodics include atropine, scopolamine, oxyphenonium, and papaverine.

Analgesics include aspirin, phenybutazone, idomethacin, sulindac, tolmetic, ibuprofen, piroxicam, fenamates, acetaminophen, phenacetin, morphine sulfate, codeine sulfate, meperidine, nalorphine, opioids (e.g., codeine sulfate, fentanyl citrate, hydrocodone bitartrate, loperamide, morphine sulfate, noscapine, norcodeine, normorphine, thebaine, nor-binaltorphimine, buprenorphine, chlomaltrexamine, funaltrexamione, nalbuphine, nalorphine, naloxone, naloxonazine, naltrexone, and naltrindole), procaine, lidocain, tetracaine and dibucaine. Ophthalmic agents include sodium fluorescein, rose bengal, methacholine, adrenaline, cocaine, atropine, alpha-chymotrypsin, hyaluronidase, betaxalol, pilocarpine, timolol, timolol salts, and combinations thereof.

Prostaglandins are art recognized and are a class of naturally occurring chemically related long-chain hydroxy fatty acids that have a variety of biological effects.

Anti-depressants are substances capable of preventing or relieving depression.

Examples of anti-depressants include imipramine, amitriptyline, nortriptyline, protriptyline, desipramine, amoxapine, doxepin, maprotiline, tranylcypromine, phenelzine, and isocarboxazide.

Trophic factors are factors whose continued presence improves the viability or longevity of a cell trophic factors include, without limitation, platelet-derived growth factor (PDGP), neutrophil-activating protein, monocyte chemoattractant protein, macrophage-inflammatory protein, platelet factor, platelet basic protein, and melanoma growth stimulating activity; epidermal growth factor, transforming growth factor (alpha), fibroblast growth factor, platelet-derived endothelial cell growth factor, insulin-like growth factor, glial derived growth neurotrophic factor, ciliary neurotrophic factor, nerve growth factor, bone growth/cartilage-inducing factor (alpha and beta), bone morphogenetic proteins, interleukins (e.g., interleukin inhibitors or interleukin receptors, including interleukin 1 through interleukin 10), interferons (e.g., interferon alpha, beta and gamma), hematopoietic factors, including erythropoietin, granulocyte colony stimulating factor, macrophage colony stimulating factor and granulocyte-macrophage colony stimulating factor; tumor necrosis factors, and transforming growth factors (beta), including beta-1, beta-2, beta-3, inhibin, and activin.

Hormones include estrogens (e.g., estradiol, estrone, estriol, diethylstibestrol, quinestrol, chlorotrianisene, ethinyl estradiol, mestranol), anti-estrogens (e.g., clomiphene, tamoxifen), progestins (e.g., medroxyprogesterone, norethindrone, hydroxyprogesterone, norgestrel), antiprogestin (mifepristone), androgens (e. g, testosterone cypionate, fluoxymesterone, danazol, testolactone), anti-androgens (e.g., cyproterone acetate, flutamide), thyroid hormones (e.g., triiodothyronne, thyroxine, propylthiouracil, methimazole, and iodixode), and pituitary hormones (e.g., corticotropin, sumutotropin, oxytocin, and vasopressin). Hormones are commonly employed in hormone replacement therapy and/or for purposes of birth control. Steroid hormones, such as prednisone, are also used as immunosuppressants and anti-inflammatoireme aspects, the additive is an agent that stimulates tissue formation, and/or healing and regrowth of natural tissues, and any combinations thereof. Agents that increase formation of new tissues and/or stimulates healing or regrowth of native tissue at the site of injection can include, but are not limited to, fibroblast growth factor (FGF), transforming growth factor-beta (TGF-beta, platelet-derived growth factor (PDGF), epidermal growth factors (EGFs), connective tissue activated peptides (CTAPs), osteogenic factors including bone morphogenic proteins, heparin, angiotensin II (A-II) and fragments thereof, insulin-like growth factors, tumor necrosis factors, interleukins, colony stimulating factors, erythropoietin, nerve growth factors, interferons, biologically active analogs, fragments, and derivatives of such growth factors, and any combinations thereof.

In some aspects, the silk composition can further comprise at least one additional material for soft tissue augmentation, e.g., dermal filler materials, including, but not limited to, poly(methyl methacrylate) microspheres, hydroxylapatite, poly(L-lactic acid), collagen, elastin, and glycosaminoglycans, hyaluronic acid, commercial dermal filler products such as BOTOX® (from Allergan), DYSPORT®, COSMODERM®, EVOLENCE®, RADIESSE®, RESTYLANE®, JUVEDERM® (from Allergan), SCULPTRA®, PERLANE®, and CAPTIQEIE®, and any combinations thereof.

In some aspects, the additive is a wound healing agent. As used herein, a “wound healing agent” is a compound or composition that actively promotes wound healing process.

Exemplary wound healing agents include, but are not limited to dexpanthenol; growth factors; enzymes, hormones; povidon-iodide; fatty acids; anti-inflammatory agents; antibiotics; antimicrobials; antiseptics; cytokines; thrombin; angalgesics; opioids; aminoxyls; furoxans; nitrosothiols; nitrates and anthocyanins; nucleosides, such as adenosine; and nucleotides, such as adenosine diphosphate (ADP) and adenosine triphosphate (ATP); neutotransmitter/neuromodulators, such as acetylcholine and 5-hydroxytryptamine (serotonin/5-HT); histamine and catecholamines, such as adrenalin and noradrenalin; lipid molecules, such as 5sphingosine-1-phosphate and lysophosphatidic acid; amino acids, such as arginine and lysine; peptides such as the bradykinins, substance P and calcium gene-related peptide (CGRP); nitric oxide; and any combinations thereof.

In certain aspects, the active agents provided herein are immunogens. In one aspect, the immunogen is a vaccine. Most vaccines are sensitive to environmental conditions under which they are stored and/or transported. For example, freezing may increase reactogenicity (e.g., capability of causing an immunological reaction) and/or loss of potency for some vaccines (e.g., HepB, and DTaP/IPV/FQB), or cause hairline cracks in the container, leading to contamination. Further, some vaccines (e.g., BCG, Varicella, and MMR) are sensitive to heat. Many vaccines (e.g., BCG, MMR, Varicella, Meningococcal C Conjugate, and most DTaP-containing vaccines) are light sensitive. See, e.g., Galazka et al., Thermostability of vaccines, in Global Programme for Vaccines & Immunization (World Health Organization, Geneva, 1998); Peetermans et al., Stability of freeze-dried rubella virus vaccine (Cendehill strain) at various temperatures, 1 J. Biological Standardization 179 (1973). Thus, the compositions and methods provided herein also provide for stabilization of vaccines regardless of the cold chain and/or other environmental conditions.

In some aspects, the additive is a cell, e.g., a biological cell. Cells useful for incorporation into the composition can come from any source, e.g., mammalian, insect, plant, etc. In some aspects, the cell can be a human, rat or mouse cell. In general, cells to be used with the compositions provided herein can be any types of cells. In general, the cells should be viable when encapsulated within compositions. In some aspects, cells that can be used with the composition include, but are not limited to, mammalian cells (e.g. human cells, primate cells, mammalian cells, rodent cells, etc.), avian cells, fish cells, insect cells, plant cells, fungal cells, spore cells, bacterial cells, and hybrid cells. In some aspects, exemplary cells that can be can be used with the compositions include platelets, activated platelets, stem cells, totipotent cells, pluripotent cells, and/or embryonic stem cells. In some aspects, exemplary cells that can be encapsulated within compositions include, but are not limited to, primary cells and/or cell lines from any tissue. For example, cardiomyocytes, myocytes, hepatocytes, keratinocytes, melanocytes, neurons, astrocytes, embryonic stem cells, adult stem cells, hematopoietic stem cells, hematopoietic cells (e.g. monocytes, neutrophils, macrophages, etc.), ameloblasts, fibroblasts, chondrocytes, osteoblasts, osteoclasts, neurons, sperm cells, egg cells, liver cells, epithelial cells from lung, epithelial cells from gut, epithelial cells from intestine, liver, epithelial cells from skin, etc., and/or hybrids thereof, can be included in the silk/platelet compositions disclosed herein. Those skilled in the art will recognize that the cells listed herein represent an exemplary, not comprehensive, list of cells. Cells can be obtained from donors (allogenic) or from recipients (autologous). Cells can be obtained, as a non-limiting example, by biopsy or other surgical means known to those skilled in the art.

In some aspects, the cell can be a genetically modified cell. A cell can be genetically modified to express and secrete a desired compound, e.g. a bioactive agent, a growth factor, differentiation factor, cytokines, and the like. Methods of genetically modifying cells for expressing and secreting compounds of interest are known in the art and easily adaptable by one of skill in the art.

Differentiated cells that have been reprogrammed into stem cells can also be used.

For example, human skin cells reprogrammed into embryonic stem cells by the transduction of Oct3/4, Sox2, c-Myc and Klf4 (Junying Yu, et. ah, Science, 2007, 318, 1917-1920 and Takahashi K. et. ah, Cell, 2007, 131, 1-12).

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, any of the features or functions of any of the embodiments disclosed herein may be incorporated into any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

### EXAMPLES

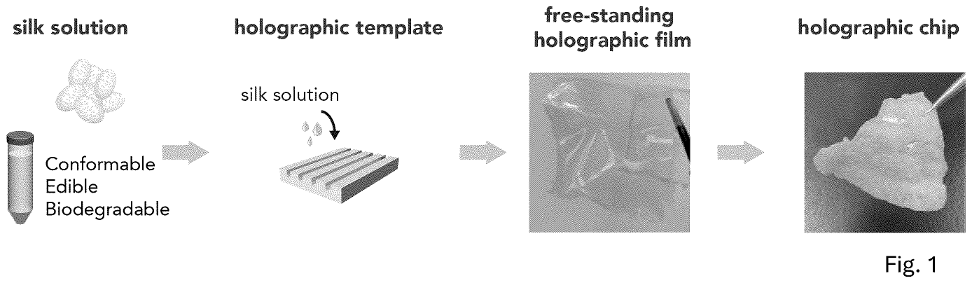

Example 1 concerns the fabrication of holographic silk coatings that can be applied on food in solid state, such as chips. Holographic thin films are obtained by casting silk fibroin solution on a diffraction grating and peeling it off the substrate once dry (FIG. 1).

Silk fibroin films with diffraction grating were fabricated by casting a low concentration silk solution on a PDMS template of a diffraction grating. Upon solution drying, a diffractive, thin-film can be peeled off from the grating. The free-standing silk grating was then applied on a solid chip. The grating retained its optical properties upon application on the chip, which then displayed holographic properties.

Transferring a water-based, edible, and biodegradable holographic film on solid food gives said food item holographic reflective properties. The use of silk film as a holographic coating could also be beneficial to prolong the food item's shelf life.

The holographic transfer may be tailored to the surface roughness of the food item being coated. For example, for wavy chips, a successful transfer method involved preparing slices of the holographic film and applying each one on the chip. Smoother food items might not require this additional step. The use of a powder made of holographic microparticles might be beneficial to have a colorful coating visible from a broad range of angles.

A sustainable method to change the optical appearance (the color) of the surface of food items is provided. No additional chemicals that might alter the original taste of the food are added.

Currently available holographic coatings are either made using materials less sustainable than silk or are directly imprinted on the food item and can dissolve upon temperature/humidity variations, whereas the silk grating can be programmed not to.

The holographic film can be applied on the solid surface of the food, or dispersed into beverages, upon suitable treatment of the silk film to make it hydrophobic.

1. A food product having an edible transferable holographic image film on at least one surface of the food product,
the edible transferable holographic image film comprising silk fibroin in an amount by weight of at least 50%, 100%,
the edible transferable holographic image film having a holographic image pattern on a first film surface and a non-patterned substrate portion,
wherein the edible transferable holographic image film has a total thickness of between 5 μm and 50 μm,
wherein the holographic image pattern has an image pattern thickness of between 150 nm and 3 μm,
wherein the holographic image pattern has lateral image feature dimensions of between 150 nm and 5 μm,
wherein the non-patterned substrate portion has a substrate thickness of between 4.85 μm and 49.85 μm,
wherein the edible transferable holographic image film has a degree of beta-sheet crystallinity that is tuned to sustain the holographic image pattern through exposure to a temperature exceeding 40 °C and/or a relative humidity exceeding 95% for at least an exposure length of time, wherein the exposure length of time is between 2 hours and 24 hours.

2. The food product of claim 1, wherein the food product is a chip.

3. The food product of claim 2, wherein the food product is a potato chip.

4. The food product of claim 1, wherein the food product is a fruit, a vegetable, meat, seafood, fish, baked goods, or a combination thereof.

5. The food product of claim 1, wherein the food product is raw.

6. The food product of claim 1, wherein the food product is cooked.

7. The food product of claimclaim 6, wherein the food product is partially cooked.

8. The food product of claim 1, wherein the food product is frozen.

9. The food product of claim 1, wherein the exposure length of time is between 3 hours and 20 hours.

10. A method of making an edible transferable holographic image film, the method comprising:
cast molding a silk fibroin solution onto a holographic image mold, the silk fibroin solution having a silk fibroin concentration by weight of between 0.01% and 1%, the holographic image mold having a depth dimension of between 150 nm and 3 μm and lateral dimensions of between 150 nm and 5 μm, thereby forming the edible transferable holographic image film within the mold, the edible transferable holographic image film comprising a holographic image pattern on a first film surface and a non-patterned substrate portion, wherein an amount of silk fibroin solution is tailored to produce a total thickness of between 5 μm and 50 μm for the edible transferable holographic image film, an image pattern thickness of between 150 nm and 3 μm and lateral image feature dimensions of between 150 nm and 5 μm for the holographic image pattern, and a substrate thickness of between 4.85 μm and 49.85 μm for the non-patterned substrate thickness;
during or after the cast molding, tuning a degree of beta sheet crystallinity in the edible transferable holographic image film to sustain the holographic image pattern through exposure to a temperature exceeding 40 °C and/or a relative humidity exceeding 95% for at least an exposure length of time, wherein the exposure length of time is between 2 hours and 24 hours; and
removing the edible transferable holographic image film from the holographic image mold,
wherein removing the edible transferable holographic image film from the holographic image mold and applying it to a food product produces an image fidelity of at least 90%

11. An edible transferable holographic image film comprising a holographic image pattern on a first film surface and a non-patterned substrate portion, the edible transferable holographic image film comprising silk fibroin in an amount by weight of at least 50%,
the edible transferable holographic image film having a holographic image pattern on a first film surface and a non-patterned substrate portion,
wherein the edible transferable holographic image film has a total thickness of between 5 μm and 50 μm,
wherein the holographic image pattern has an image pattern thickness of between 150 nm and 3 μm,
wherein the holographic image pattern has lateral image feature dimensions of between 150 nm and 5 μm,
wherein the non-patterned substrate portion has a substrate thickness of between 4.85 μm and 49.85 μm,
wherein the edible transferable holographic image film has a degree of beta-sheet crystallinity that is tuned to sustain the holographic image pattern through exposure to a temperature exceeding 40 °C and/or a relative humidity exceeding 95% for at least an exposure length of time, wherein the exposure length of time is between 2 hours and 24 hours.

12. The food productof claim 1, wherein a ratio between the image pattern thickness and the substrate thickness is between 1:5000 and 1:2.

13. The food product of claim 1, wherein the total thickness is at least 5 μm and at most 50 μm.

14. The food product of claim 1, wherein the image pattern thickness is at least 150 nm.

15. The food product of claim 1, wherein the lateral image feature dimensions are at least 150 nm.

16. The food product of claim 1, wherein the substrate thickness is at least 4.85 μm, and at most 49.85 μm.

17. The food product of claim 1, wherein the degree of beta-sheet crystallinity is tuned to sustain the holographic image pattern through exposure to the temperature exceeding 40 °C.

18. The food product of claim 1, wherein the degree of beta-sheet crystallinity is tuned to sustain the holographic image pattern through exposure to the relative humidity exceeding 95%.

19. The food product, of claim 1, wherein the edible transferable holographic image film is flavorless.

20. The food product of claim 1, wherein the edible transferable holographic image film further comprises at least one of a flavorant, a colorant, and/or a nutritional supplement (e.g., a vitamin).

21.-72. (canceled)
